(19) United States
(12) Patent Application Publication
(10) Pub. No.: US 2026/0147741 A1
(43) Pub. Date: May 28, 2026

(54) HASH TABLE CREATION DEVICE, METHOD, AND PROGRAM

(71) Applicant: NEC Corporation, Tokyo (JP)

(72) Inventor: Yoshiyuki OHNO, Tokyo (JP)

(73) Assignee: NEC Corporation, Tokyo (JP)

(21) Appl. No.: 19/364,014

(22) Filed: Oct. 21, 2025

(30) Foreign Application Priority Data
Nov. 26, 2024 (JP) 2024-205065

(51) Int. Cl. G06F 16/22

(52) U.S. Cl. CPC G06F 16/2255

(57) ABSTRACT

A mask-condition checking unit that, for each thread to which rows divided from a table are respectively assigned, acquires, from among rows of the assigned table, a row index that is identification information of a row that matches a mask condition that is a condition for specifying data in the table. A hash table creation unit that, for keys of the table corresponding to all the acquired row indexes, for each thread, acquires a value of a row that matches a key condition set for the respective thread, and inserts into a hash table row data associated with the key of the table.

### CROSS-REFERENCE TO RELATED APPLICATIONS

This application is based upon and claims the benefit of priority from the prior Japanese Patent Application No. 2024-205065, filed November 26, 2024, the entire contents of which are incorporated herein by reference.

### BACKGROUND OF THE INVENTION

The present disclosure relates to a hash table creation device, a hash table creation method, and a hash table creation program that create a hash table.

A hash table stores multiple pairs of keys and values and is a data structure used to reference a value corresponding to a key. Hash tables are also used when implementing table-data join processing ("JOIN") and grouping processing ("GROUP BY").

For example, Patent Literature 1 describes a method for creating a hash table. In the method described in Patent Literature 1, division data is generated by dividing a data set into a plurality of sections having a predetermined number of bits. At the time of registering the data set, a hash table is created that associates a hash value having a predetermined number of bits with a pointer corresponding to NULL, and a tree is constructed that uses the respective hash tables as nodes.

### Prior Art Documents

### Patent Documents

[Patent Literature 1] Japanese Unexamined Patent Application Publication No. 2020-119363

### SUMMARY OF THE INVENTION

In the join processing described above, it is often the case that only data satisfying a condition is targeted for processing. For example, in program code, processing is performed before and after the join that filters data according to a condition. This processing can be realized by creating a conditional hash table.

One way to quickly create a hash table composed of data that satisfies a condition is parallel processing by multiple threads. On the other hand, although parallel processing can speed up processing, it also gives rise to overhead.

Accordingly, an example object of the disclosure is to provide a hash table creation device, a hash table creation method, and a hash table creation program that can reduce overhead when creating, by parallel processing, a hash table composed of data that satisfies conditions.

The hash table creation device according to the present disclosure includes: a mask-condition checking unit that, for each thread to which rows divided from a table are respectively assigned, acquires, from among rows of the assigned table, a row index that is identification information of a row that matches a mask condition that is a condition for specifying data in the table; and a hash table creation unit that, for keys of the table corresponding to all the acquired row indexes, for each thread, acquires a value of a row that matches a key condition set for the respective thread, and inserts into a hash table row data associated with the key of the table.

The hash table creation method according to the present disclosure includes: acquiring, for each thread to which rows divided from a table are respectively assigned, from among rows of the assigned table, a row index that is identification information of a row that matches a mask condition that is a condition for specifying data in the table; and for keys of the table corresponding to all the acquired row indexes, acquiring, for each thread, a value of a row that matches a key condition set for the respective thread, and inserting into a hash table row data associated with the key of the table.

The hash table creation program according to the present disclosure causes a computer to execute: mask-condition checking processing that, for each thread to which rows divided from a table are respectively assigned, acquires, from among rows of the assigned table, a row index that is identification information of a row that matches a mask condition that is a condition for specifying data in the table; and hash table creation processing that, for keys of the table corresponding to all the acquired row indexes, acquires, for each thread, a value of a row that matches a key condition set for the respective thread, and inserts into a hash table row data associated with the key of the table.

According to the present disclosure, overhead can be reduced when creating, by parallel processing, a hash table composed of data that satisfies conditions.

### BRIEF DESCRIPTION OF DRAWINGS

FIG. 1 is a block diagram illustrating a configuration example of the hash table creation device according to the present disclosure.

FIG. 2 is an explanatory diagram illustrating an example method for creating a conditional hash table.

FIG. 3 is an explanatory diagram illustrating an example method for creating a hash table.

FIG. 4 is an explanatory diagram illustrating an example method for creating a hash table.

FIG. 5 is an explanatory diagram illustrating an example method for creating a hash table by parallel processing.

FIG. 6 is an explanatory diagram illustrating an example method for creating a conditional hash table by parallel processing.

FIG. 7 is an explanatory diagram illustrating an example of parallel processing.

FIG. 8 is an explanatory diagram illustrating an example process of dividing data among threads.

FIG. 9 is an explanatory diagram illustrating an example process for creating a hash table.

FIG. 10 is an explanatory diagram illustrating another example process for creating a hash table.

FIG. 11 is a flowchart illustrating an example operation of the hash table creation device.

FIG. 12 is a block diagram illustrating an overview of the hash table creation device according to the present disclosure.

FIG. 13 is a schematic block diagram illustrating a configuration of a computer according to at least one example embodiment.

### DETAILED DESCRIPTION OF THE INVENTION

Hereinafter, example embodiments of the present disclosure will be described with reference to the drawings.

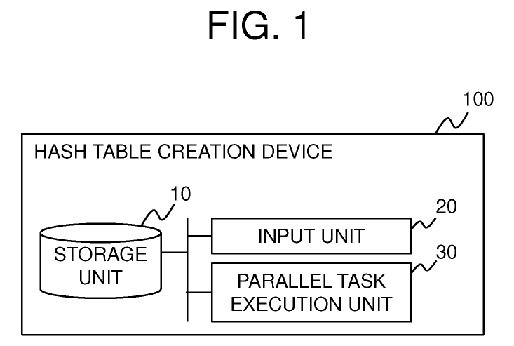

FIG. 1 is a block diagram illustrating an example configuration of the hash table creation device according to the present disclosure. A hash table creation device 100 according to this example embodiment includes a storage unit 10, an input unit 20, and a parallel task execution unit 30.

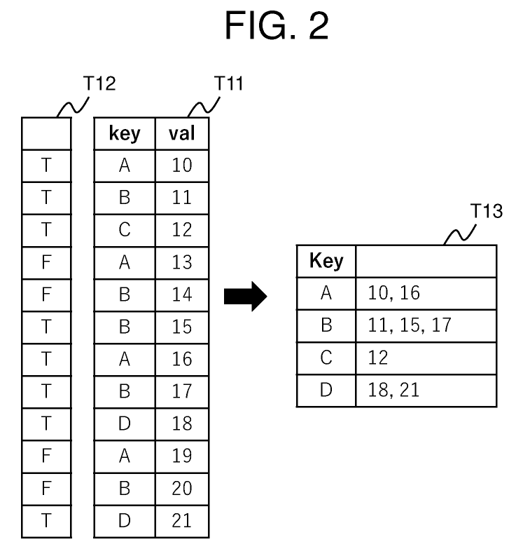

First, a method for creating a hash table composed of data that satisfies a condition (hereinafter, also referred to as a "conditional hash table") will be described. A hash table is a data structure that stores multiple pairs of keys and values and is used to reference a value corresponding to a key. FIG. 2 is an explanatory diagram illustrating an example method for creating a conditional hash table.

As illustrated in FIG. 2, with respect to a table T11, a mask-condition checking step is first executed. In the present disclosure, a mask condition refers to a condition for specifying data in a designated table. One example of a mask condition is a condition specified in a WHERE clause of SQL (Structured Query Language).

In the mask-condition checking step, all data included in the table T11 is sequentially processed from the top. As a result, a mask value indicating data in the table T11 that satisfies the mask condition is set to T (True), and mask values as illustrated in a table T12 are obtained. Next, a key acquisition step is executed to acquire keys whose mask value is T. Then, for each acquired key, a hash table insertion step is executed to insert values into a hash table T13.

Next, a method for creating a hash table by parallel processing (parallel program) will be described. When creating a single hash table by parallel processing, after data included in a target table is divided, a separate hash table is created in parallel for each divided data assigned to each thread, and the created hash tables are combined. Methods for dividing data include a method of evenly dividing the data and a method of dividing the data according to values.

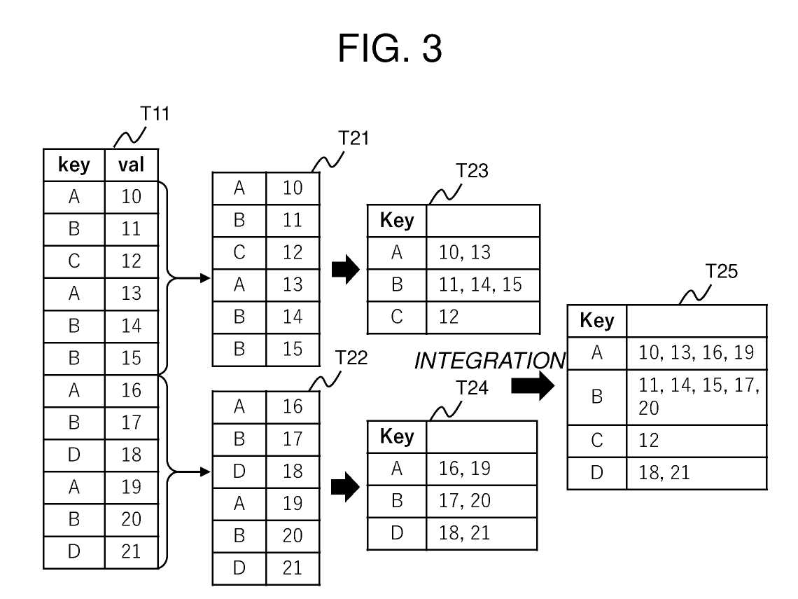

FIG. 3 is an explanatory diagram illustrating an example method for creating a hash table by evenly dividing data. In the example illustrated in FIG. 3, first, 12 items of data in the table T11 are divided into 6 items each (tables T21 and T22). Then, two hash tables T23 and T24 are independently created from the respective data, and the two created hash tables are combined to create a final hash table T25.

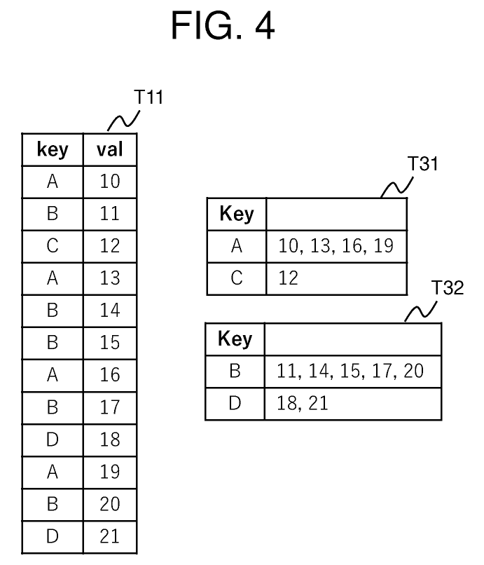

FIG. 4 is an explanatory diagram illustrating an example method for creating a hash table by dividing data according to values. Here, a remainder obtained by dividing a value (val) corresponding to a key by a predetermined divisor is defined. In the example illustrated in FIG. 4, it is defined that A mod 2 = 0, B mod 2 = 1, C mod 2 = 0, and D mod 2 = 1.

Thereafter, a key-condition checking step is executed to check key conditions (hereinafter simply referred to as "key conditions"), and a hash table T31 is created to which only data of "mod 2 is 0" is added, and a hash table T32 is created to which only data of "mod 2 is 1" is added. In the example illustrated in FIG. 4, since hash tables are created for each key according to values, join processing is unnecessary.

In the example illustrated in FIG. 4, a method of dividing data according to remainders (mod) is exemplified. For example, if a range of keys is known, the data may be divided according to the range of the keys.

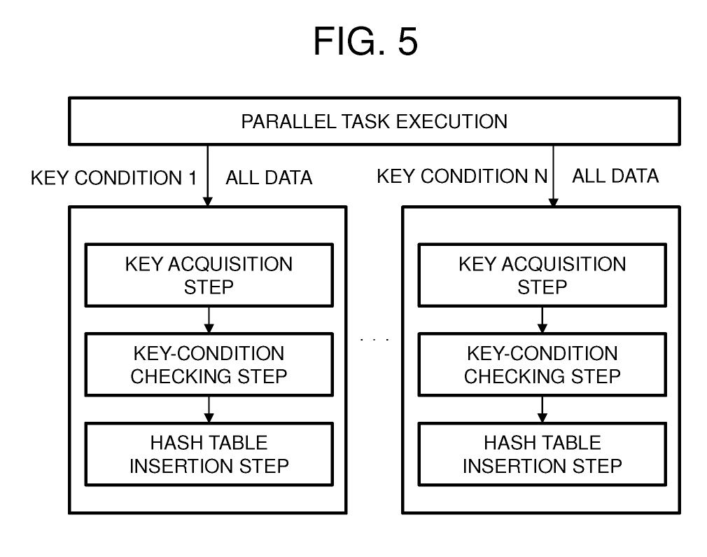

FIG. 5 is an explanatory diagram illustrating an example method for creating a hash table by parallel processing. The method illustrated in FIG. 5 summarizes the methods illustrated in FIGS. 3 and 4. That is, in order to execute parallel tasks, different key conditions are set for each thread. In each thread, all data is sequentially processed in accordance with the set key condition (specifically, the key acquisition step, the key-condition checking step, and the hash table insertion step).

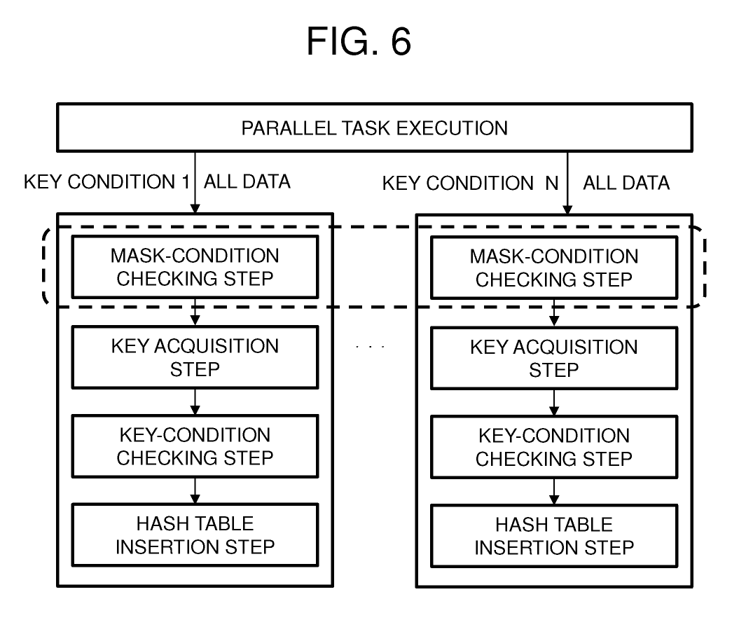

Next, a method for creating a conditional hash table by parallel processing will be described. FIG. 6 is an explanatory diagram illustrating an example method for creating a conditional hash table by parallel processing. Compared with the processing illustrated in FIG. 5, processing for checking mask conditions (mask-condition checking step) is performed on all data in the table.

Here, the inventor has noted that, when executing parallel tasks, generally, the same mask-condition checking process is performed in all threads. That is, in a naive method of creating a conditional hash table by parallel processing, all threads execute the same mask-condition checking step for all data. The inventor noticed that execution of the same mask-condition checking step by all threads produces much processing overhead.

In other words, in the case of creating a conditional hash table in parallel, in the naive method, each thread performs mask-condition checking and key-condition checking for all data. That is, since all threads perform mask-condition checking for all data, redundant processing is performed. Accordingly, in the present disclosure, a method for reducing overhead by making processing more efficient will be described.

The storage unit 10 stores various information used in processing by the hash table creation device 100 of this example embodiment. The storage unit 10 of this example embodiment also stores a table that is a target when creating a hash table, and the created hash table. The storage unit 10 may be implemented by, for example, a magnetic disk or the like.

The input unit 20 receives an input of an instruction to create a hash table. Specifically, the input unit 20 receives an input specifying a table that is a target for creating a hash table, and an input of a condition (that is, a mask condition) for specifying data in the designated table. The input unit 20 may also receive an input of a table that is a target for creating a hash table.

The input unit 20 may receive an input of an instruction to create a hash table from another device (not shown) that operates in conjunction with the hash table creation device 100 of the present disclosure, or may receive an input of an instruction to create a hash table from a user.

The parallel task execution unit 30 executes processing for creating a single hash table in parallel by multithreading. The number of threads that execute parallel processing is predetermined.

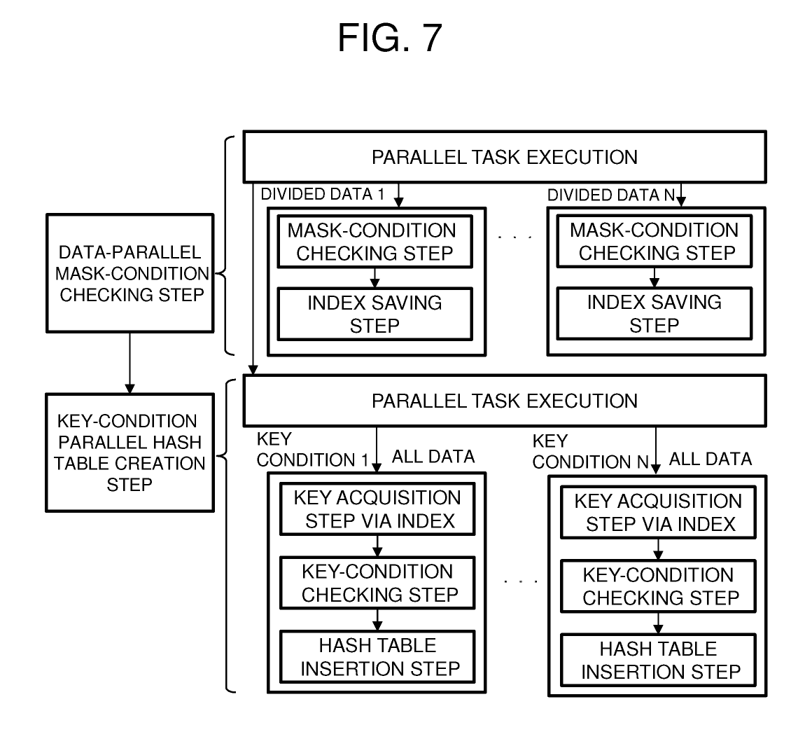

FIG. 7 is an explanatory diagram illustrating an example of parallel processing performed by the parallel task execution unit 30. The parallel processing for creating a hash table performed by the parallel task execution unit 30 is largely divided into a "data-parallel mask-condition checking step" and a "key-condition parallel hash table creation step."

In the data-parallel mask-condition checking step, processing is performed for each thread to which rows divided from a table are respectively assigned. On the other hand, in the key-condition parallel hash table creation step, processing is performed for each thread on all row data obtained as a result of the data-parallel mask-condition checking step. Hereinafter, processing performed by the parallel task execution unit 30 will be specifically described.

First, the parallel task execution unit 30 acquires, for each thread to which rows divided from a table are respectively assigned identification information of a row (hereinafter, row index) that matches a condition that is a condition for specifying data in the table (that is, mask condition), from among rows of the assigned table. The row index is, for example, a row number or a pointer to a row.

The parallel task execution unit 30 may divide rows included in a table and assign them to respective threads. The parallel task execution unit 30 may also acquire, from among rows of a table assigned to a thread, a row index that matches the mask condition.

The method by which the parallel task execution unit 30 divides data is arbitrary. It is preferable that the parallel task execution unit 30 divide data uniformly so that processing is not biased among the threads. For example, as illustrated in FIGS. 3 and 4, the parallel task execution unit 30 may divide data evenly, or may divide data according to values or ranges of values.

By doing so, compared with the processing illustrated in FIG. 6, the processing targets for checking mask conditions can be reduced for each thread, and therefore overhead in creating a hash table by parallel processing can be reduced.

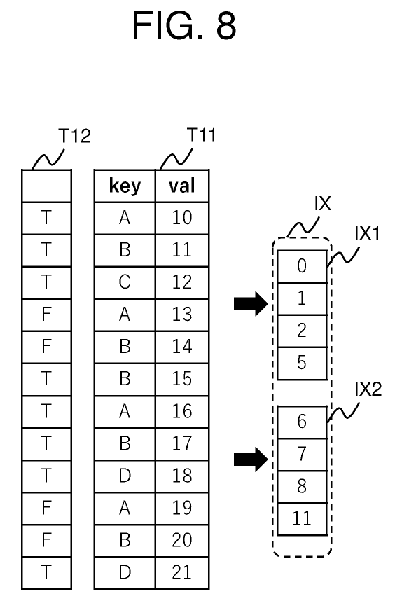

FIG. 8 is an explanatory diagram illustrating an example process of dividing data among threads. The parallel task execution unit 30 divides data of the table T11 and data of the table T12 indicating mask values equally (six items each) from the beginning. Then, for each thread, the parallel task execution unit 30 acquires row indexes IX1 and IX2 of rows that match the mask condition from among rows of the assigned table. As a result, a row index IX obtained by combining two row indexes is obtained.

Next, the parallel task execution unit 30 acquires, for each thread, rows corresponding to the acquired row indexes from a target table. For keys of the target table corresponding to all the acquired row indexes, the parallel task execution unit 30, for each thread, acquires a value of a row that matches a key condition set for the respective thread, and inserts into a hash table row data (also sometimes referred to as row data) associating the key of the table with the acquired value. By these processes, the hash table is created.

Key conditions set for each thread are defined by a plurality of key conditions in such a way that rows included in a table can be acquired exhaustively and exclusively. One example of a key condition is a condition indicated by a remainder (mod) exemplified in FIG. 4.

Here, two methods are assumed as methods of acquiring rows corresponding to acquired row indexes from a target table. The first method targets all the acquired row indexes and acquires rows corresponding to the row indexes from the table in each thread. The second method first targets only row indexes acquired in each thread, acquires rows corresponding to the row indexes from the table in parallel for each thread, and integrates the acquisition results.

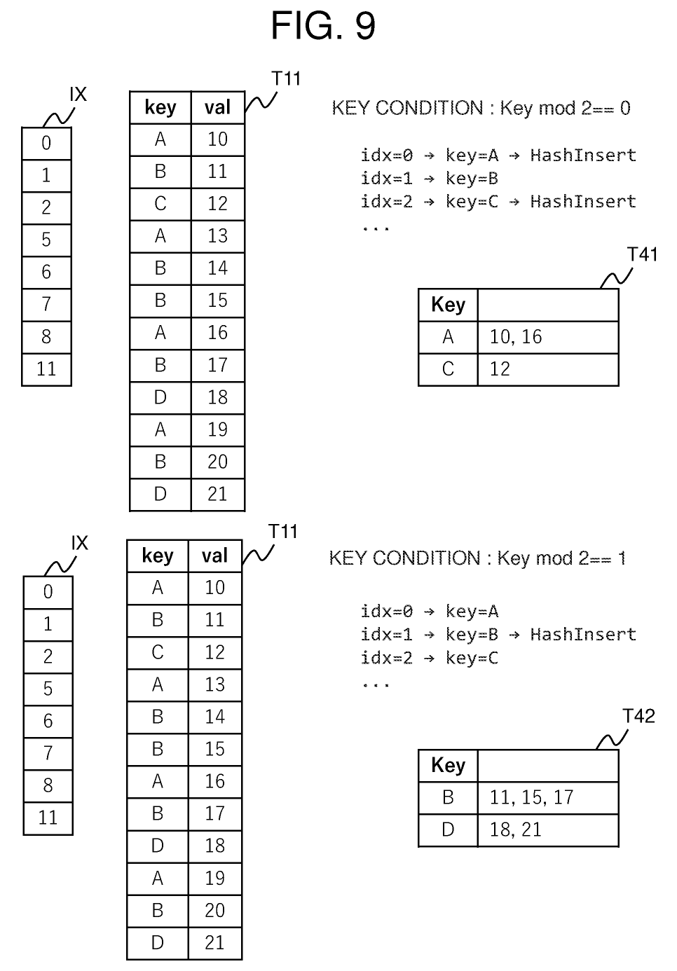

Hereinafter, each method will be specifically described. FIG. 9 is an explanatory diagram illustrating an example process of creating a hash table using the first method. In the example illustrated in FIG. 9, a remainder (mod) of a key is used as the key condition, and is assumed to be set for each thread.

First, the parallel task execution unit 30 acquires rows corresponding to the acquired row indexes IX from the table T11. Here, values of each column of the index IX are denoted as idx. Next, the parallel task execution unit 30 acquires rows whose keys match the key condition set for the thread from among the acquired rows.

For example, as illustrated in FIG. 9, when "Key mod 2 == 0" is set as the key condition for a thread, the parallel task execution unit 30 acquires a row specified by idx = 0 that matches the key condition. The same applies to other rows. Then, the parallel task execution unit 30 inserts into a hash table T41 row data associating the key (key = A) of the table with the acquired value (10) of the row. The same processing is performed for a thread in which "Key mod 2 == 1" is set, and a hash table T42 is generated.

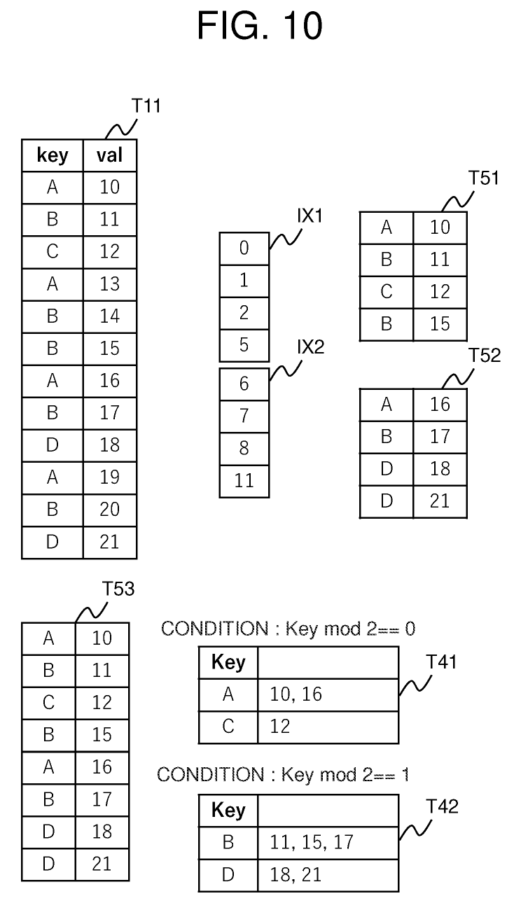

Next, the second method will be described. FIG. 10 is an explanatory diagram illustrating an example process of creating a hash table using the second method. In the example illustrated in FIG. 10 as well, a remainder (mod) of a key is used as the key condition, and is assumed to be set for each thread.

First, the parallel task execution unit 30 targets row indexes IX1 and IX2 acquired in each thread, and acquires rows corresponding to these row indexes from the table T11 in parallel for each thread. As a result, a set of rows T51 and a set of rows T52 are obtained. The parallel task execution unit 30 integrates these acquisition results and obtains a set of rows T53.

Thereafter, as in the method illustrated in FIG. 9, the parallel task execution unit 30 acquires rows whose keys match the key condition set for the thread from among the acquired rows, and inserts into hash tables T41 and T42 row data associating the keys of the table with the acquired values of the rows.

Here, the processing amount (cost) of the first method and the second method will be described. In the first method, since each thread refers to the index and the entire table, the number of times memory is read with respect to the index and the table (specifically, the key) becomes equal to the number of threads, and the number of times values (Val) are read is once.

On the other hand, in the second method, a set of rows is first acquired from the index. Accordingly, when acquiring the set of rows, the number of times memory is read and written is one for the index, and one each for the key and the value (Val) of the table. Furthermore, when creating a hash table, the index is not read, so the number of times memory is read with respect to the key of the table becomes equal to the number of threads, and the number of times values (Val) are read is once.

As described above, the read and write processing amount differs depending on the method. This processing amount varies according to characteristics of data, in other words, the amount of data. Specifically, when much of the data in a table is data that should actually be processed, the first method can be said to be effective. On the other hand, when little of the data in a table is data that should actually be processed, the second method can be said to be effective. The number of data items that should actually be processed varies depending on the mask condition.

Therefore, the parallel task execution unit 30 may calculate a ratio of the number of rows that match the mask condition to the number of rows of the table. The parallel task execution unit 30 may select the first method when the ratio is greater than a predetermined threshold, and may select the second method when the ratio is equal to or less than the predetermined threshold. The threshold is predetermined by an administrator or the like based on past statistics or the like.

The input unit 20 and the parallel task execution unit 30 are implemented by a processor (for example, a CPU (Central Processing Unit)) of a computer that operates according to a program (hash table creation program). For example, the program is stored in the storage unit 10 of the hash table creation device 100, and the processor may read the program, and operate as the input unit 20 and the parallel task execution unit 30 in accordance with the program.

Further, each function of the hash table creation device 100 may be provided in the form of SaaS (Software as a Service). Further, the input unit 20 and the parallel task execution unit 30 may each be implemented by dedicated hardware.

Further, part or all of the components of each device may be implemented by a general-purpose or dedicated circuit (circuitry), a processor, or a combination thereof. These may be configured by a single chip, or by a plurality of chips connected via a bus. Part or all of the components of each device may be implemented by a combination of the above-described circuit and a program.

Further, when part or all of the components of the hash table creation device 100 are implemented by a plurality of information processing devices or circuits, the plurality of information processing devices or circuits may be centrally arranged or may be distributed. For example, the information processing devices or circuits may be implemented in a client-server system or a cloud computing system, each connected via a communication network.

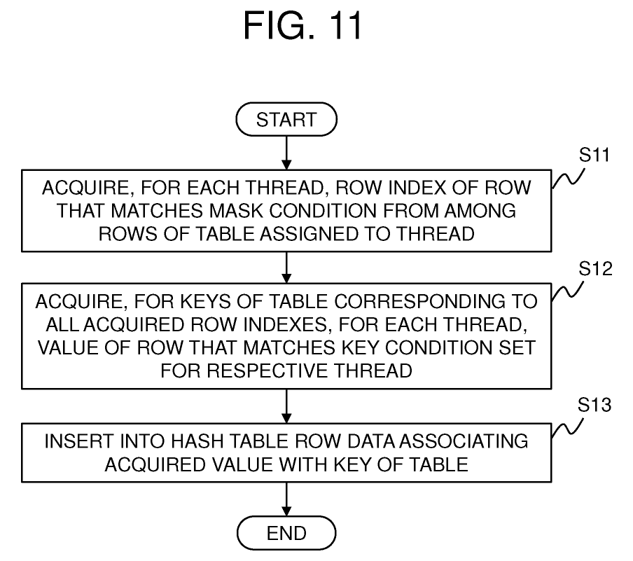

Next, an example operation of the hash table creation device 100 of this example embodiment will be described. FIG. 11 is a flowchart illustrating an example operation of the hash table creation device 100 of this example embodiment.

The parallel task execution unit 30 acquires, for each thread, a row index of a row that matches a mask condition from among rows of the table assigned to the thread (step S11). The parallel task execution unit 30 acquires, for keys of the table corresponding to all the acquired row indexes, for each thread, a value of a row that matches a key condition set for the respective thread (step S12). Then, the parallel task execution unit 30 inserts into a hash table row data associating the acquired value with the key of the table (step S13).

As described above, according to this example embodiment, the parallel task execution unit 30 acquires, for each thread, a row index of a row that matches a mask condition from among rows of the table assigned to the thread, and, for keys of the table corresponding to all the acquired row indexes, acquires, for each thread, a value of a row that matches a key condition set for the respective thread. Then, the parallel task execution unit 30 inserts into a hash table row data associating the acquired value with the key of the table. Therefore, overhead can be reduced when creating, by parallel processing, a hash table composed of data that satisfies conditions.

That is, since all threads do not perform mask-condition checking processing for all data, but rather perform mask-condition checking in data-parallel processing, waste in parallel computation can be reduced.

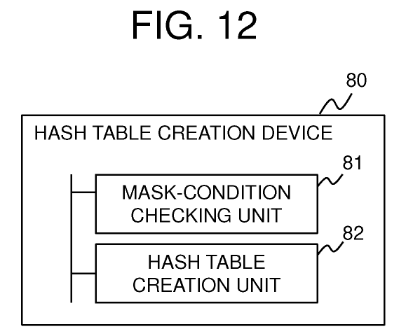

Next, an overview of the present disclosure will be described. FIG. 12 is a block diagram illustrating an overview of the hash table creation device according to the present disclosure. A hash table creation device 80 according to the present disclosure (for example, the hash table creation device 100) includes: a mask-condition checking unit 81 (for example, the parallel task execution unit 30) that, for each thread to which rows divided from a table are respectively assigned, acquires, from among rows of the assigned table, a row index that is identification information of a row that matches a mask condition that is a condition for specifying data in the table; and a hash table creation unit 82 (for example, the parallel task execution unit 30) that, for keys of the table corresponding to all the acquired row indexes, acquires, for each thread, a value (for example, val) of a row that matches a key condition set for the respective thread, and inserts into a hash table row data (for example, Key + Val) associated with the key of the table.

With such a configuration, overhead can be reduced when creating, by parallel processing, a hash table composed of data that satisfies conditions.

The hash table creation unit 82 may acquire, for each thread, a row corresponding to the acquired row index from the table, acquire a row whose key matches the key condition set for the thread, and insert into the hash table row data associating the keys of the table with the acquired values of the rows.

Specifically, the hash table creation unit 82 may acquire, for each thread, all rows corresponding to all the acquired row indexes from the table (for example, the first method described above), acquire rows whose keys match the key condition set for the thread, and insert into the hash table row data associating the keys of the table with the acquired values of the rows.

Alternatively, the hash table creation unit 82 may target row indexes acquired in each thread, acquire rows corresponding to the row indexes from the table in parallel for each thread, integrate the acquired results (for example, the second method described above), acquire rows whose keys match the key condition set for the thread, and insert into the hash table row data associating the keys of the table with the acquired values of the rows.

The hash table creation unit 82 may calculate a ratio of the number of rows that match the mask condition to the number of rows of a table, and when the ratio is greater than a predetermined threshold, acquire, for each thread, all rows corresponding to all the acquired row indexes from the table, and when the ratio is equal to or less than the predetermined threshold, acquire rows corresponding to row indexes acquired in each thread from the table in parallel for each thread, and integrate the acquisition results.

Key conditions set for the respective threads (for example, conditions defined by remainders) may be defined by a plurality of key conditions in such a way that rows included in the table can be acquired exhaustively and exclusively.

The mask-condition checking unit 81 may divide rows included in a table and assign them to the respective threads, and acquire, for each thread, a row index that matches the mask condition from among rows of the table assigned to the thread.

The mask-condition checking unit 81 may assign, to the respective threads, rows of the table divided according to equality, values, or ranges of values.

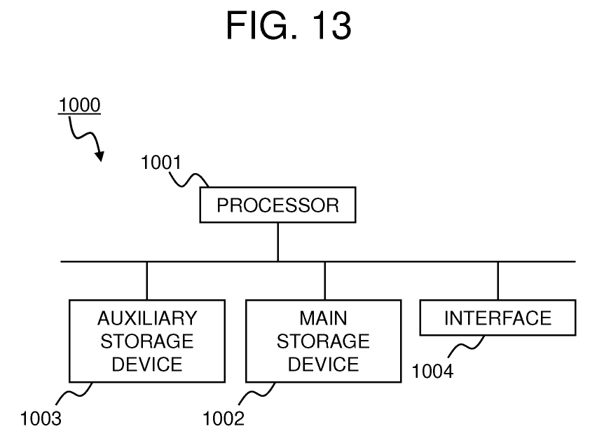

FIG. 13 is a schematic block diagram illustrating a configuration of a computer according to at least one example embodiment. A computer 1000 includes a processor 1001, a main storage device 1002, an auxiliary storage device 1003, and an interface 1004. Further, the computer 1000 may be connected to a computer that executes a mathematical programming solver, an annealing machine, a simulator, or the like.

The above-described hash table creation device 80 is implemented in the computer 1000. Operations of the processing units described above are stored in the auxiliary storage device 1003 in the form of a program (hash table creation program). The processor 1001 reads the program from the auxiliary storage device 1003, expands it into the main storage device 1002, and executes the above-described processing according to the program.

In at least one example embodiment, the auxiliary storage device 1003 is an example of a non-transitory tangible medium. Other examples of non-transitory tangible media include a magnetic disk, a magneto-optical disk, a CD-ROM (Compact Disc Read-only Memory), a DVD-ROM (Read-only Memory), or a semiconductor memory, connected via the interface 1004. Further, when this program is distributed to the computer 1000 via a communication line, the computer 1000 that has received the distribution may expand the program into the main storage device 1002 and execute the above-described processing.

The program may be for realizing part of the above-described functions. Furthermore, the program may be a so-called difference file (difference program) that realizes the above-described functions in combination with another program already stored in the auxiliary storage device 1003.

Some or all of the example embodiments described above may also be described as follows, but are not limited thereto.

(Supplementary Note 1) A hash table creation device comprising: a mask-condition checking unit that, for each thread to which rows divided from a table are respectively assigned, acquires, from among rows of the assigned table, a row index that is identification information of a row that matches a mask condition that is a condition for specifying data in the table; and a hash table creation unit that, for keys of the table corresponding to all the acquired row indexes, for each thread, acquires a value of a row that matches a key condition set for the respective thread, and inserts into a hash table row data associated with the key of the table.

(Supplementary Note 2) The hash table creation device according to Supplementary Note 1, wherein the hash table creation unit acquires, for each thread, a row corresponding to the acquired row index from the table, acquires a row whose key matches the key condition set for the thread, and inserts into the hash table row data associating the key of the table with the acquired value of the row.

(Supplementary Note 3) The hash table creation device according to Supplementary Note 2, wherein the hash table creation unit acquires, for each thread, all rows corresponding to all the acquired row indexes from the table, acquires rows whose keys match the key condition set for the thread, and inserts into the hash table row data associating the keys of the table with the acquired values of the rows.

(Supplementary Note 4) The hash table creation device according to Supplementary Note 2, wherein the hash table creation unit targets row indexes acquired in each thread, acquires rows corresponding to the row indexes from the table in parallel for each thread, integrates the acquired results, acquires rows whose keys match the key condition set for the thread, and inserts into the hash table row data associating the keys of the table with the acquired values of the rows.

(Supplementary Note 5) The hash table creation device according to Supplementary Note 2, wherein the hash table creation unit calculates a ratio of the number of rows that match the mask condition to the number of rows of the table, and when the ratio is greater than a predetermined threshold, acquires, for each thread, all rows corresponding to all the acquired row indexes from the table, and when the ratio is equal to or less than the predetermined threshold, acquires rows corresponding to row indexes acquired in each thread from the table in parallel for each thread, and integrates the acquired results.

(Supplementary Note 6) The hash table creation device according to any one of Supplementary Notes 1 to 5, wherein key conditions set for the respective threads are defined by a plurality of key conditions in such a way that rows included in the table can be acquired exhaustively and exclusively.

(Supplementary Note 7) The hash table creation device according to any one of Supplementary Notes 1 to 5, wherein the mask-condition checking unit divides rows included in the table and assigns them to the respective threads, and acquires, for each thread, a row index that matches the mask condition from among rows of the table assigned to the thread.

(Supplementary Note 8) The hash table creation device according to any one of Supplementary Notes 1 to 5, wherein the mask-condition checking unit assigns, to the respective threads, rows of the table divided according to equality, values, or ranges of values.

(Supplementary Note 9) A hash table creation method comprising: acquiring, for each thread to which rows divided from a table are respectively assigned, from among rows of the assigned table, a row index that is identification information of a row that matches a mask condition that is a condition for specifying data in the table; and for keys of the table corresponding to all the acquired row indexes, acquiring, for each thread, a value of a row that matches a key condition set for the respective thread, and inserting into a hash table row data associated with the key of the table.

(Supplementary Note 10) A hash table creation program for causing a computer to execute: mask-condition checking processing that, for each thread to which rows divided from a table are respectively assigned, acquires, from among rows of the assigned table, a row index that is identification information of a row that matches a mask condition that is a condition for specifying data in the table; and hash table creation processing that, for keys of the table corresponding to all the acquired row indexes, acquires, for each thread, a value of a row that matches a key condition set for the respective thread, and inserts into a hash table row data associated with the key of the table.

While the present invention has been described with reference to the example embodiments and examples above, the present invention is not limited to the above-described embodiments and examples. Various modifications to the configuration and details of the present invention can be made by those skilled in the art within the scope of the present invention.

1. A hash table creation device comprising:
a memory storing instructions; and
one or more processors configured to execute the instructions to:
acquire, for each thread to which rows divided from a table are respectively assigned, from among rows of the assigned table, a row index that is identification information of a row that matches a mask condition that is a condition for specifying data in the table; and
for keys of the table corresponding to all the acquired row indexes, acquire, for each thread, a value of a row that matches a key condition set for the respective thread, and insert into a hash table row data associated with the key of the table.

2. The hash table creation device according to claim 1,
wherein the processor is configured to execute the instructions to acquire, for each thread, a row corresponding to the acquired row index from the table, acquire a row whose key matches the key condition set for the thread, and insert into the hash table row data associating the key of the table with the acquired value of the row.

3. The hash table creation device according to claim 2,
wherein the processor is configured to execute the instructions to acquire, all rows corresponding to all the acquired row indexes from the table, acquire rows whose keys match the key condition set for the thread, and insert into the hash table row data associating the keys of the table with the acquired values of the rows.

4. The hash table creation device according to claim 2,
wherein the processor is configured to execute the instructions to target row indexes acquired in each thread, acquire rows corresponding to the row indexes from the table in parallel for each thread, integrate the acquired results, acquire rows whose keys match the key condition set for the thread, and insert into the hash table row data associating the keys of the table with the acquired values of the rows.

5. The hash table creation device according to claim 2,
wherein the processor is configured to execute the instructions to calculate a ratio of the number of rows that match the mask condition to the number of rows of the table, and when the ratio is greater than a predetermined threshold, acquire, for each thread, all rows corresponding to all the acquired row indexes from the table, and when the ratio is equal to or less than the predetermined threshold, acquire rows corresponding to row indexes acquired in each thread from the table in parallel for each thread, and integrate the acquired results.

6. The hash table creation device according to claim 1,
wherein key conditions set for the respective threads are defined by a plurality of key conditions in such a way that rows included in the table can be acquired exhaustively and exclusively.

7. The hash table creation device according to claim 1,
wherein the processor is configured to execute the instructions to divide rows included in the table and assign them to the respective threads, and acquire, for each thread, a row index that matches the mask condition from among rows of the table assigned to the thread.

8. The hash table creation device according to claim 1,
wherein the processor is configured to execute the instructions to assign, to the respective threads, rows of the table divided according to equality, values, or ranges of values.

9. A hash table creation method comprising:
acquiring, for each thread to which rows divided from a table are respectively assigned, from among rows of the assigned table, a row index that is identification information of a row that matches a mask condition that is a condition for specifying data in the table; and
for keys of the table corresponding to all the acquired row indexes, acquiring, for each thread, a value of a row that matches a key condition set for the respective thread, and inserting into a hash table row data associated with the key of the table.

10. A non-transitory computer readable information recording medium storing a hash table creation program, when executed by a processor, that performs a method for:
acquiring, for each thread to which rows divided from a table are respectively assigned, from among rows of the assigned table, a row index that is identification information of a row that matches a mask condition that is a condition for specifying data in the table; and
for keys of the table corresponding to all the acquired row indexes, acquiring, for each thread, a value of a row that matches a key condition set for the respective thread, and inserting into a hash table row data associated with the key of the table.
